(19) United States
(12) Patent Application Publication
(10) Pub. No.: US 2017/0038131 A1
(43) Pub. Date: Feb. 9, 2017

(54) COLD STORAGE METHODS

(71) Applicants: Joseph Naumovitz, Lebanon, NJ (US); Martin Kibili, Kleinaitingen (DE)

(72) Inventors: Joseph Naumovitz, Lebanon, NJ (US); Martin Kibili, Kleinaitingen (DE)

(21) Appl. No.: 14/818,921

(22) Filed: Aug. 5, 2015

(51) Int. Cl. F25J 1/00; F17C 13/00

(52) U.S. Cl. CPC F25J 1/0012; F17C 13/00; F17C 2221/031

(57) ABSTRACT

In a liquid air energy system, cold storage is accomplished using heat pipes as the heat transfer device. The cold energy storage unit is charged by feeding high pressure air to a liquid cold storage unit wherein the high pressure air becomes liquid air; feeding the liquid air to a liquid air storage unit; feeding cold liquid to the liquid cold storage unit wherein the cold liquid becomes warm liquid; and feeding warm liquid to a warm liquid storage unit.

### BACKGROUND OF THE INVENTION

A heat pipe is a heat-transfer device that combines the principles of both thermal conductivity and phase transition to efficiently manage the transfer of heat between two solid interfaces.

In liquid air energy storage (LAES), air is liquefied and stored when electricity is being overproduced. During periods of high electricity demand and consequent high prices, liquid air is pressurized, vaporized and expanded for electricity generation possibly supported by a gas turbine.

Compared to conventional air separation technology, air liquefaction and the evaporation of liquid nitrogen and/or oxygen is uncoupled by time periods in which either liquefaction (charging LAES) or evaporation (discharging LAES) occurs. A cold heat storage concept is capable of storing energy at cryogenic temperatures while discharging the LAES system and utilizing that stored cryogenic energy for the next LAES charging cycle.

As large amounts of heat storage fluids are required, they must not only meet the technical requirements but also be relatively inexpensive. Hydrocarbon fluids are typically use but they do come with safety concerns as in the case of a leaking in a hydrocarbon-air heat exchanger where there is potential for an explosive mixture to form.

Heat pipes enable heat transfer between the cold storage media and the air/liquid air without risking the formation of an explosive gas mixture in case of leakages.

### SUMMARY OF THE INVENTION

In one embodiment of the invention, there is disclosed a method for charging a cold energy storage unit comprising the steps:

Feeding high pressure air to a liquid cold storage unit wherein the high pressure air becomes liquid air;

Feeding the liquid air to a liquid air storage unit;

Feeding cold liquid to the liquid cold storage unit wherein the cold liquid becomes warm liquid; and

Feeding warm liquid to a warm liquid storage unit,

In another embodiment of the invention, there is disclosed an apparatus for the cold storage of energy comprising high pressure air storage means in fluid communication with a liquid cold storage unit which is in fluid communication with liquid air storage means; cold liquid tank means in fluid communication with the liquid cold storage unit which is in fluid communication with warm liquid tank means; the liquid cold storage unit comprising heat pipe means.

The liquid cold storage unit contains heat pipes. The heat pipes may be in bundles of heat pipes and the heat pipes may contain a refrigerant selected from the group consisting of carbon dioxide, carbon tetrafluoride, freons and nitrogen.

The liquid cold storage unit contains a refrigerant. The liquid cold storage unit will receive heat from the warm liquid tank and dispense cold to the liquid air during charge. Two or more liquid cold storage units may be connected in series. The liquid cold storage unit may comprise two chambers containing a working fluid.

The heat pipes connect the two chambers and are in contact with the working fluid.

The conversion of liquid air to high pressure air provides a source of energy for electricity generation. This electricity generation may be by operation of a gas turbine.

### BRIEF DESCRIPTION OF THE DRAWINGS

FIG. 1 is a schematic of the liquid cold storage system during charging mode per the invention described herein.

FIG. 2 is a schematic of the liquid cold storage system during discharging mode per the invention described herein.

### DETAILED DESCRIPTION OF THE INVENTION

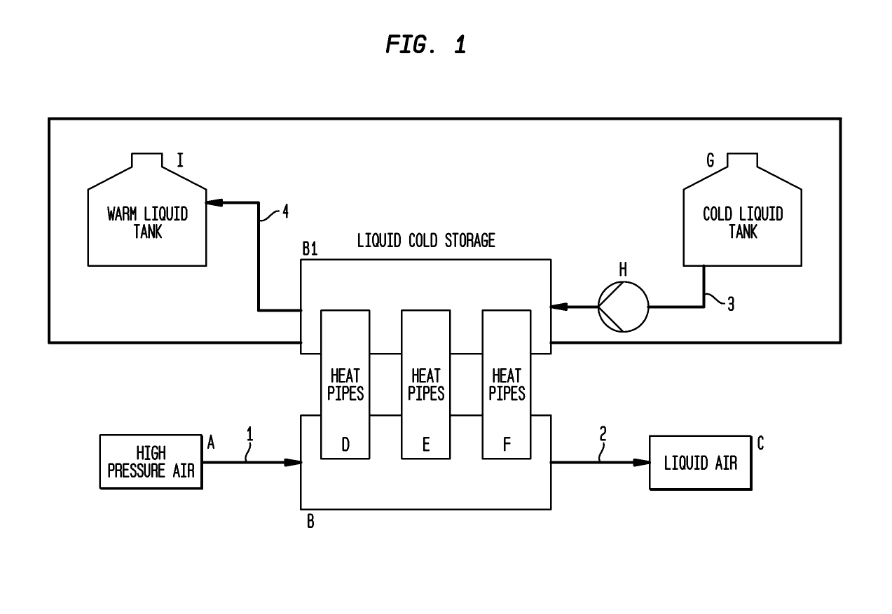

FIG. 1 shows a schematic liquid air energy storage system according to the invention. Heat pipes designated D, E and F are instrumental in providing refrigeration through heat exchange. During the LAES charging mode, high pressure air from compression system A is fed through line 1 to the refrigeration unit B that contains heat pipes D, E and F. The high pressure air may be provided through ambient air compression and pre-treatment which are typical state of the art steps in liquefying air and are not shown in the depiction of the LAES system. The high pressure air is liquefied and will be fed through line 2 to storage unit C for the liquid air.

The working fluid in the bottoms of the heat pipes D, E and F will be evaporated and transported to the top of the individual heat pipe where it will be condensed again.

The required cold energy is provided by the cold liquid tank G which contains a hydrocarbon such as methanol. The cold liquid is fed through line 3 and pump H to the refrigeration unit B1 where it will contact the heat pipes D, E and F. The cold liquid will warm up through this contact and be fed through line 4 to the warm liquid tank for storage.

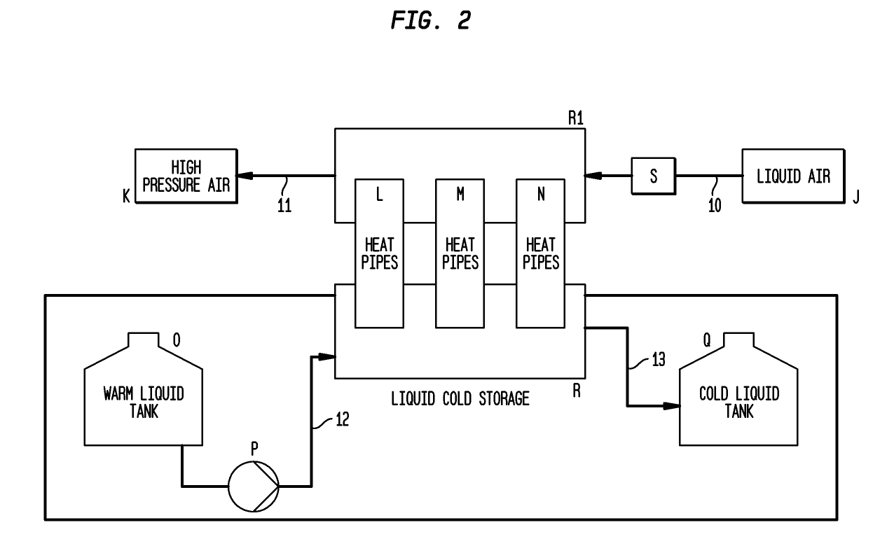

In FIG. 2, the LAES discharging mode is shown. The warm liquid which may be a hydrocarbon such as methanol is fed from tank O through pump P and line 12 to the refrigeration unit R. The warm liquid will contact the heat pipes L, M and N and receive refrigeration there from. The now cold liquid is fed from the refrigeration unit R through line 13 to the cold liquid tank Q.

The working fluids in the bottoms of the heat pipes L, M and N will transfer the heat from the warm liquid to the tops of the respective heat pipes. Liquid air in storage unit J will be pumped up in pressure through pump S and fed through line 10 to the refrigeration unit R1 where it will contact the warmer temperature heat pipes L, M and N which will cause the liquid air to warm up and become high pressure air which will pass from the refrigeration unit R through line 11 to form high pressure air K which can be used in an expansion engine to produce electricity.

Alternatively, the refrigeration unit, liquid cold storage could be divided into individual sections inside the storage tank such that the heat pipes would be disposed within an individual section of the storage tank. These individual sections could then be at different temperatures and allow for a more efficient operation as only one storage tank would be required instead of two tanks for each cold storage system in series.

Due to the big temperature range that is required to liquefy air from ambient temperatures, two or more liquid cold storage systems may be applied in series using different cold storage liquids. The utilization of the latent heat of fusion inside of the cold liquid tank may be considered to reduce the required volumes of the storage liquids,

The refrigeration unit may contain the necessary number of heat pipes or heat pipe bundles that are needed to be applied in series to cover the whole temperature range of air liquefaction. This number can vary depending upon air liquefaction performance and overall economics. The working fluids present in the heat pipes should not form explosive mixtures when combined with air or hydrocarbons/methanol. Suitable working fluids are typically carbon dioxide, carbon tetrafluoride, other types of freons and nitrogen. The heat pipes or bundles will operate at different pressure profiles to match the temperature profiles for air liquefaction.

While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit and scope of the present invention.

Having thus described the invention, what we claim is:

1. A method for charging a cold energy storage unit comprising the steps:
Feeding high pressure air to a liquid cold storage unit wherein the high pressure air becomes liquid air;
Feeding the liquid air to a liquid air storage unit;
Feeding cold liquid to the liquid cold storage unit wherein the cold liquid becomes warm liquid; and
Feeding warm liquid to a warm liquid storage unit.

2. The method as claimed in claim 1 wherein the liquid cold storage unit contains heat pipes.

3. The method as claimed in claim 2 wherein the heat pipes are in bundles of heat pipes.

4. The method as claimed in claim 2 wherein the heat pipes contain a refrigerant selected from the group consisting of carbon dioxide, carbon tetrafluoride, freons and nitrogen.

5. The method as claimed in claim I wherein the liquid cold storage unit contains a refrigerant.

6. The method as claimed in claim 1 wherein the liquid cold storage unit will receive heat from the warm liquid tank and dispense cold to the liquid air during discharge.

7. The method as claimed in claim 1 wherein two or more liquid cold storage units are connected in series.

8. The method as claimed in claim 1 wherein the liquid cold storage unit comprises two chambers containing a working fluid.

9. The method as claimed in claim 2 wherein the heat pipes connect the two chambers and are in contact with the working fluid.

10. The method as claimed in claim 1 wherein the heating of pressurized liquid aft to high pressure air provides a source of energy for electricity generation.

11. The method as claimed in claim 10 wherein the electricity generation is by expansion of the warmed high pressure air in a turbine.

12. An apparatus for the cold storage of energy comprising high pressure air storage means in fluid communication with a liquid cold storage unit which is in fluid communication with liquid air storage means; cold liquid tank means in fluid communication with the liquid cold storage unit which is in fluid communication with warm liquid tank means; the liquid cold storage unit comprising heat pipe means.

13. The apparatus as claimed in claim 12 wherein the liquid cold storage unit contains heat pipes.

14. The apparatus as claimed in claim 13 wherein the heat pipes are in bundles of heat pipes.

15. The apparatus as claimed in claim 13 wherein the heat pipes contain a refrigerant selected from the group consisting of carbon dioxide, carbon tetrafluoride, freons and nitrogen.

16. The apparatus as claimed in claim 12 wherein the liquid cold storage unit contains a refrigerant.

17. The apparatus as claimed in claim 12 wherein two or more liquid cold storage units are connected in series.

18. The apparatus as claimed in claim 12 wherein the liquid cold storage unit comprises two chambers containing a working fluid.

19. The apparatus as claimed in claim 12 wherein the heat pipes connect the two chambers and are in contact with the working fluid.
